(19) United States
(12) Patent Application Publication
(10) Pub. No.: US 2016/0278187 A1
(43) Pub. Date: Sep. 22, 2016

(54) SMART LIGHT ADAPTER WITH ENGERY MEASUREMENT CAPABILITY

(71) Applicant: Cielo WiGle Inc., Redmond, WA (US)

(72) Inventors: Waseem Amer, Islamabad (PK); Anees Ahmed Jarral, Islamabad (PK)

(21) Appl. No.: 15/069,296

(22) Filed: Mar. 14, 2016

Related U.S. Application Data
(60) Provisional application No. 62/133,504, filed on Mar. 16, 2015.

(51) Int. Cl. H05B 37/02

(52) U.S. Cl. CPC H05B 37/0272; H05B 37/0227

(57) ABSTRACT

A Smart Light Adapter with energy measurement and control capabilities is described herein. The smart light adapter enables a user to control, monitor and manage their lights and their energy consumption both locally and remotely by taking advantage of an onboard integrated Wi-Fi and implemented algorithms. The user can send control commands to the smart light adapter via an application installed on a mobile device. The smart light adapter connects to already deployed Wi-Fi router at user location to use it as a bridge to communicate between the user, cloud and itself. Consequently; it eliminates the need of any additional hub or concentrator which is a primary requirement in ZigBee, Z-Wave or similar technology. The onboard power management unit ensures optimal use of power by the device. The onboard energy measurement unit measures the actual energy consumption of relevant light to show the actual usage statistics and relevant costs to the user.

### CROSS REFERENCE TO RELATED APPLICATION(S)

This application claims the benefit of U.S. Provisional Patent Application No. 62/133,504 entitled “Smart Light Adapter with Energy Metering capability,” filed on Mar. 16, 2015, which is hereby incorporated by reference in its entirety.

### FIELD OF INVENTION

The present invention relates generally to Machine to Machine (“M2M”) communication technology and the Internet of Things (“IoT”) industry. More specifically it relates to the control, monitor, and energy measurement/management of devices such as light producing devices (hereafter referred to as light or lights or light bulbs) by providing remote and/or local access and/or control to the user.

### BACKGROUND

Technical innovations in the Machine to Machine (M2M) and Internet of Things (IoT) industry have enabled users to access, control and manage electronic devices through wireless connections from anywhere in the world. The trends are fast growing to remotely control, monitor and manage electronic devices, actuators and sensors. The increased connectivity options have unleashed avenues to connect, control, monitor and manage consumer electronics devices or appliances, more specifically lights. Users are desirous to control lights remotely by using their smart phones, tablets, wearable devices, TVs, web application, etc. For example, a user may want to control their light and exactly know its energy usage to save energy and relevant costs.

Users in today's world have multiple types of lights both at their homes and offices. These lights are normally controlled by their switches. With the advent of latest technology, innovative ways are being explored to control lights conveniently and provide energy efficiency. There are inherent drawbacks of the light switches e.g. they do not offer remote control and information of energy consumption to the user. In addition, for example, if the switch of a light malfunctions, there remains hardly any choice but to get the switch back in proper functional mode in order to control the light. Additionally, the legacy light control switches at user locations do not offer any means of location independent control of lights to the user. Similarly these do not offer intelligent analytics that can be used as a source to take energy saving measures.

Current smart home control systems that allow users to control their lights remotely (e.g., turn the light ON/OFF or change the intensity of the light using a software application installed on a mobile device) suffer from a lot of drawback such as requiring consumers to purchase new smart light bulbs that replace their older or legacy light bulbs. Current solutions do not address ways to turn a legacy light producing device (e.g. light bulb that doesn't contain a connectivity module to receive commands from other devices via protocols used by Wi-Fi systems, Bluetooth systems, ZigBee systems, etc.) into a smart light. Current smart home control systems don't measure and report energy consumption, and do not calculate estimated cost of energy consumed for consumers to see before receiving their utility bills. Current systems do not give consumers insight into their energy spending habits on a day-to-day basis, or any time the consumer wants to see details about their energy usage/estimated costs. Current smart home systems do not break down energy consumption on an appliance-by-appliance basis, day-by-day, etc. Current smart home control systems do not allow consumers to define criteria or parameters to force the smart home control system to intelligently execute functions to save energy. Example of such functions include the automatic deactivation or alteration of the operation of an appliance (e.g. light bulb, air conditioner, TV, refrigerator, swimming pool heater, dishwasher, dryer, washing machine, etc.) in response to an energy consumption threshold being exceeded.

What is desirable is a smart home control system that solves all of the above issues that existing smart home control systems have not addressed.

### SUMMARY

The invention presented here comprises of various methods, smartly integrated subsystems, sensors and algorithms as per one or more of the presented embodiments to provide users a location independent control over their appliances and show their real time energy usage. The subject innovation eliminates the need of any additional requirement of specialized home automation control hub or protocol conversion device by using the existing Wi-Fi hub already deployed at user location to give location independent control to the user over their appliances. The physical design of the described smart adapter can be modified to work with specific appliances by coupling it to the appliance or embedding/integrating it into the appliance. In one embodiment, the smart adapter is a smart light adapter since it is specifically designed to be coupled to a light socket and a light bulb. The innovative smart light adapter offers a unique solution for users to deploy between their light and light socket. The smart light adapter offers the interoperability features thus making it possible to associate the smart light adapter with one light type and later disassociate from the same and associate with another light type as per users' choice and convenience.

Presented are the methods, algorithms, subsystems of the smart light adapter along with the data capture and storage applications for effective user analytics to help them smartly manage and control lights irrespective of their location. The implementation of presented methods, algorithms and subsystems leads to a cloud smart light adapter for lights preferably dimmable lights. These methods, algorithms, subsystem and the application in one or more of the embodiments or a combination thereof; are presented as a patentable matter.

The cloud enabled smart light adapter for lights with its methods, subsystems, algorithms, computer programs and various embodiments to achieve the user required actions is presented. The presented system aims at providing users with control over their lights and show real time energy consumption of each light to the user irrespective of user location and brand/or manufacturer of the light.

The operation of some appliances can be conditional and based on reported energy consumption from multiple other appliances. For example, the described system can turn on an air conditioner in the guest room if the energy consumption threshold has not exceeded x kWh (kilowatt hour) or the total cost of energy consumption has not exceed x $ amount. The threshold can be set by the user. For example, the user can set the threshold in spending dollars and the described smart system will manage the operation of the appliances or selected set of appliances (as defined by the user), and the energy consumption accordingly.

The described system uses intelligent algorithms to measure energy consumption, calculate estimated cost, and makes decisions on operation of some or all available appliances to save energy. Since electricity costs (e.g. $/kWh) vary between countries, states, cities, counties, and utility providers, the described energy management system uses location to calculate costs, determine the utility provider to therefore determine cost per kWh. The described system also uses the operation timestamps of the various appliances to measure energy consumption costs since most providers operate on a tier-based pricing model. For example, Utility provider A might charge more per kWh at certain times during the day. Taking this into account, the described system will prioritize the operation of some appliances over other appliances. For example, the swimming pool heater takes less priority over air conditioner, and the refrigerator takes priority over both, i.e., the swimming pool heater and the air conditioner.

The smart light adapter has an onboard Wi-Fi module as its communication subsystem. The Wi-Fi module with implemented programs supports both Direct and client mode operations and choice is made by the device depending upon the requirement of operation and power metric indicators. Smart light adapter has a microcontroller based processing and decision making engine. The programmatic and algorithmic flows are implemented in the onboard memory and are updated by the cloud application platform as required. These programmatic and algorithmic flows with the help of onboard rules engine enable the smart light adapter for machine learning and taking intelligent decisions as per user habits for energy savings. The device has onboard power management unit. The communication mechanisms, intelligent rules engine, algorithmic and programmatic flows offer a reliable solution for the user.

The concept of connected world is fast growing in Internet of Things (IoT) and Machine to Machine (M2M) industry. Users are looking to control their lights and exactly see their real time energy consumption for energy saving from anywhere in the world. The emphasis is fast growing for a single solution that can address both legacy lights already with users and newly purchased lights. The presented methods, subsystem, related details and its embodiment make it possible to address these user needs effectively.

In some of the embodiments the smart light adapter is enabled for intelligent decision making through implemented algorithmic flows and optimized user analytics for energy efficient use of lights by the user thus contributing to energy conservation. The overall system provides control, monitoring and management with the provision of scheduler and activity log database. The choices and multiple implementation and operational embodiments are summarized in the succeeding paragraphs.

The overall system consists of the smart light adapter(s), smartphone(s), user(s), cloud platform, web application, communication medium and the light(s). The user(s), smart phone(s), cloud platform, web application and communication medium remain common in each of the embodiments or applications. The use of one or more presented smart light adapters to control light(s) is dependent on the user's choice. The user can choose to deploy one smart light adapter with one light to control, monitor and manage the operation of said light irrespective of their location.

In some of the embodiments the user can choose to deploy multiple smart light adapters at the same location for multiple lights i.e. one smart light adapter per light for cloud enabled control, monitoring and management of said lights irrespective of user location.

In some of the embodiments there can be multiple users assigned to one light thus leveraging cloud enabled control, monitoring and management capabilities to said users for assigned light through the associated smart light adapters.

In some of the embodiments there can be multiple users assigned to multiple smart light adapters thus leveraging cloud enabled control, monitoring and management capabilities to said users for assigned lights through the associated smart light adapters. Such implementation offers the family architecture of system usage and operation under various embodiments.

In some of embodiments there can be one user assigned to multiple lights through associated smart light adapters that are geographically apart. In some of the embodiments there can be multiple users assigned to multiple lights through associated smart light adapters that are geographically apart. The presented system supports seamless assignment of user(s) through interactive graphical user interface and backend algorithmic and programmatic flows for effective remote monitoring, control and management of lights through associated smart light adapters. Smart light adapter enables users to use legacy light switch if desired in parallel.

In some of the embodiments the steps for signup of the user for smartphone application include choosing a unique email address, username, password and confirming the passwords through the graphical user interface. The provided data by the user is logged in the backend cloud platform database. The steps for signing in are providing the username or selecting an already displayed username on the graphical user interface and entering the password.

The registration of smart light adapter can be done through scanning the QR code provided on the packaging or on the smart light adapter itself and associating it with the desired light as per user's choice The same process is repeated for registration of multiple devices. This is just one convenient method for registering the smart light adapter. For example, the registration can be done manually by the user by entering the smart light adapter ID. Another method for registering the smart light adapter can occur upon powering up the smart light adapter, since it acts as an Access Point (AP) and broadcasts its name. A user can directly connect to the smart light adapter by utilizing the app installed on their mobile device (e.g., smartphone) to complete the registration. Therefore, the user doesn't have to manually enter the ID associated with the smart light adapter or scan the QR code.

The graphical user interface of the application offers to create a new family or join an existing family. The user has the option to link the smart light adapter with their available Wi-Fi router at its location. The graphical user interface of the application offers the user to assign roles and rights for usage to various family members. The user(s) can set the schedulers, notifications and other functions as per desire through the graphical user interface of the application.

The smartphone application offers multiple graphical information subsystems to the user for analytics of the logged data about usage, status, and related vital information.

The smart light adapter is capable of Firmware Upgrade over the Air (FOTA). The new release of firmware is communicated to the smart light adapter over Wi-Fi connectivity.

In some of the application embodiments there can be single or multiple users assigned to the multiple lights through associated smart light adapters. In case the user(s) are out of premises, the remote monitoring, management and control of assigned lights are offered to the user(s) through their smart phones. The user can connect to the desired light through internet interface and Wi-Fi router at smart light adapter location. The data is communicated to and from the smart light adapter through the cloud platform and local Wi-Fi router. The smart light adapter uses onboard subsystem to control the associated light for appropriate actions. The data is logged in the database of cloud platform for effective user analytics. The smart light adapter sends an acknowledgement to the user after it has taken appropriate actions on the user commands.

In some of the application embodiments user(s) commands from local user(s) are communicated to the smart light adapter through smartphone of the local user and local Wi-Fi router at smart light adapter location. The smart light adapter sends the acknowledgement signal back to the user smartphone through local Wi-Fi router. In addition, the data is sent to cloud platform database for activity log through local Wi-Fi router at its location.

In some of the application embodiments user(s) commands from local user(s) are communicated to the smart light adapter through Wi-Fi module of the smartphone of local user at smart light adapter location. The smart light adapter takes appropriate actions and sends the acknowledgement signal back to the user smartphone through Wi-Fi communication. The smartphone of local user established the communication link with cloud platform database for activity log through public cellular telephone infrastructure.

### BRIEF DESCRIPTION OF THE DRAWING(S)

FIG. 1A illustrates overall system components in some embodiments including smart light adapter 10, cloud platform 50, a locally deployed Wi-Fi router 100, and a software application 61 (e.g., mobile application, web application) executing on user electronic devices such as mobile device 60, tablets, laptops, wearable devices, smart TVs, etc.

FIG. 1B illustrates the block diagram of the Smart Light Adapter. The onboard communication section, brightness control section, energy measurement section, processing section, power management unit and status section are illustrated.

FIG. 1C shows the structure design and form factor for the smart light adapter. As the design file shows, the smart light adapter adds a maximum of 1.579 inches to the height of the light bulb. The smart light adapter contains the circuitry to perform functions such as ON/OFF, brightness control and energy measurement, and connects to other devices directly or indirectly via an onboard communication section. The block diagram for the circuit board is shown in FIG. 1B. It should be noted that this structure design can work for variety of light bulbs, such as light bulbs with E27 light socket, light bulbs with base types of Edison E10 to E40, Bayonet B15, B22 and Bi-Post and Bi-Pin.

FIG. 2 is a high-level schematic diagram illustrating logical relationships among systems in some arrangements within which the technology can operate.

FIG. 3 is a block diagram of the system illustrating main subsystems i.e. user, smartphone and cloud application platform and a plurality of connected smart light adapters presented as invention here.

FIG. 4 is a high-level schematic diagram illustrating embodiments in which the technology can control appliances at multiple properties.

FIG. 5 is a high-level schematic diagram where a user is capable of communicating, controlling, monitoring and managing multiple lights directly through smartphone and smart light adapters.

FIG. 6 a high-level schematic diagram where multiple users are capable of communicating, controlling, monitoring and managing multiple lights directly through smartphones and associated smart light adapters thus illustrating a concept of family or group.

FIGS. 7A-7E are high-level schematic diagrams illustrating communication arrangements through which local and/or remote users can control appliances in various embodiments of the technology

FIG. 8 is a block diagram illustrating the command operation section in accordance with some embodiments of the technology.

FIG. 9 illustrates the onboard programmatic and algorithmic flows of the smart light adapter.

FIG. 10 illustrates the onboard programmatic and algorithmic flows of the smart light adapter at power up.

FIG. 11 illustrates the onboard choice and selection of communication subsystems available on the smart light adapter.

FIG. 12 illustrates the signup and startup screens of the smartphone application to provide seamless graphical user interface to the user.

FIG. 13 illustrates the screens of smartphone applications used to register the smart light adapters and associating these with appropriate lights.

FIG. 14 illustrates the creation, defining and joining functions of family/group of users through smartphone application.

FIG. 15 illustrates the smart light adapter setup screens of smartphone application and linking the smart light adapter(s) with available Wi-Fi router(s) at the user location.

FIG. 16 illustrates the main screen and the drop down options of smartphone application including reports, notifications, family/group, lights and settings.

FIG. 17 illustrates the screens of smartphone application supporting family/group features. The association of one or multiple lights to one or multiple members can be configured through these screens of the application.

FIG. 18 illustrates the screens of smartphone application showing energy usage information to the user of the lights. The graphical presentation of information is also highlighted.

FIG. 19 illustrates the screens of smartphone application showing parameter based energy usage information to the user of the lights. The graphical presentation of information is also highlighted.

FIG. 20 illustrates the screens of smartphone application offering energy usage control capability to the user for each light. This feature of the application plays a vital role in energy saving and providing energy efficiency to the user.

FIG. 21 illustrates the reports and graphical presentation of user analytics for user information.

FIGS. 22A-22B illustrates the smartphone application screens for scheduler and timer automation configuration for one or multiple smart light adapter(s) by the user(s).

FIG. 23 is a display diagram illustrating a timeline screen in accordance with some embodiments of the technology.

### DETAILED DESCRIPTION OF THE PREFERRED EMBODIMENT(S)

The following description is intended to convey an understanding of the invention by providing a number of specific embodiments. It is understood, however, that the invention is not limited to these exemplary embodiments and details.

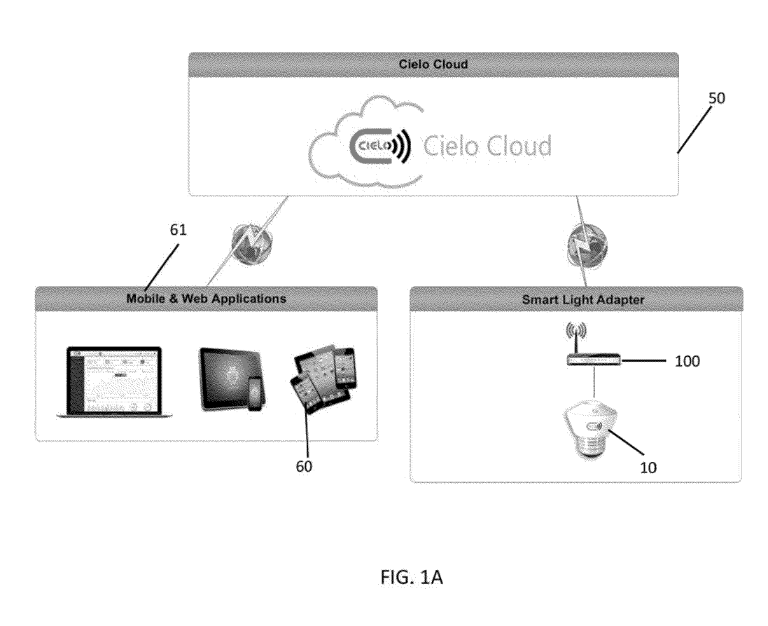

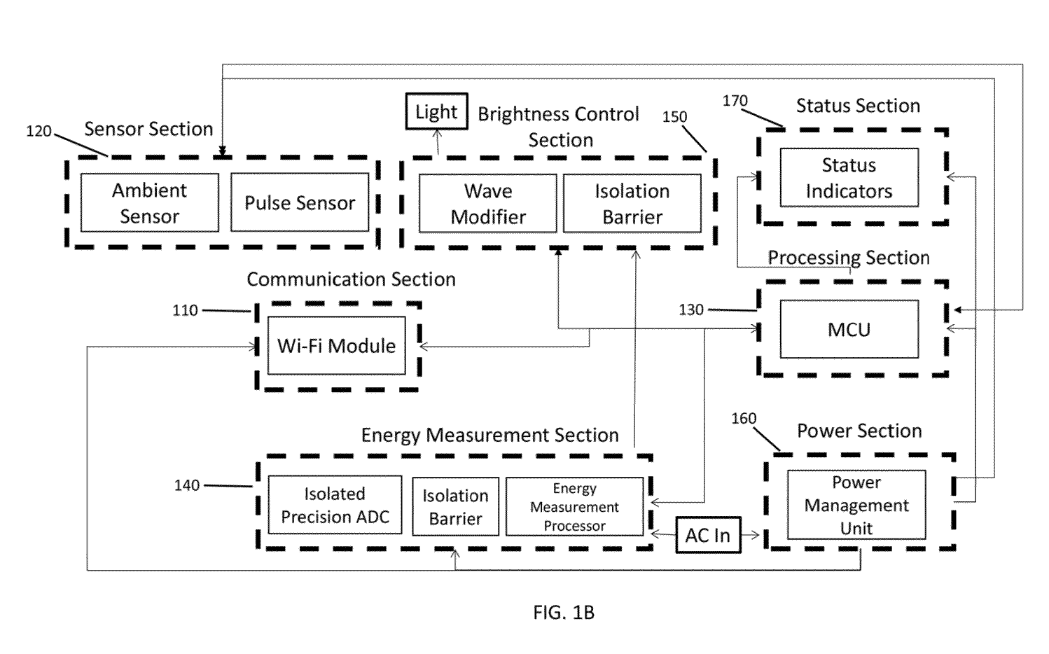

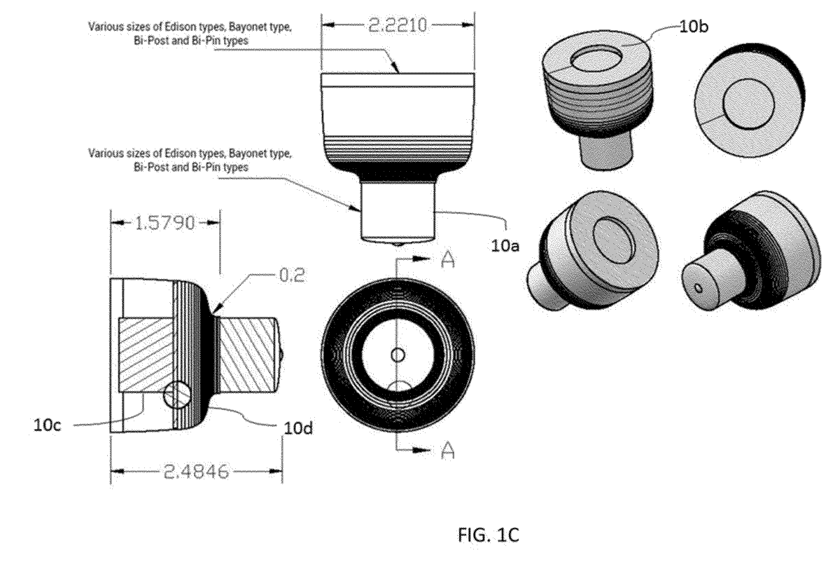

FIG. 1A is a high-level schematic diagram illustrating logical relationships among systems in some arrangements within which the technology can operate. FIG. 1A illustrates overall system components in some embodiments including smart light adapter 10; a cloud platform 50, e.g., including a database and application; a locally deployed Wi-Fi router 100; and a mobile or web application (e.g., on user electronic devices such as mobile device 60, tablets, laptops, etc.). FIG. 1A illustrates communication links between the system components. The smart light adapter 10 connects to a cloud application platform 50 through a Wi-Fi router 100 at the smart light adapter 10 location via a communication module of smart light adapter 10.

In various embodiments, the cloud platform 50 provides cloud storage (e.g., cache) and database services. The cloud platform 50 acts as a bridge between hardware and/or software of smart light adapter 10, mobile devices 60, and web applications 61. For example, the cloud platform 50 provides utilities for mobile applications to communicate with a database server through predefined application programming interfaces (“APIs”). The cloud platform 50 service use APIs to store smart light adapter 10 data on a cloud database, so that the data is secure and accessible by the user anywhere. The cloud platform 50 provides services for encryption and decryption of commands and data, maintaining privacy of the user. The cloud platform 50 maintains information about smart light device 10 status and provides services for scheduling, statistics, and triggers for firmware over-the-air (“FOTA”) updates of smart light device 10.

User actions are recorded and stored in the cloud application platform 50. For example, in various embodiments of the technology, an activity log is stored in the central database of cloud application platform 50 and acknowledgments and/or notifications are sent to one or more users through smartphone 60 mobile or web application 61.

The cloud platform 50 and mobile or web application 61 manage data including data at rest, referring to inactive data that is stored physically in any digital form (e.g. databases, data warehouses etc.), and data in transit, referring to information that flows over a public or untrusted network such as the Internet and data that flows in the confines of a private network such as a corporate or enterprise Local Area Network (LAN). In various embodiments, the cloud platform 50 and mobile or we application 61 include security measures such as storing all data in secure data centers with a trusted service provider, using intrusion detection and intrusion prevention systems, and using distributed computing technology to improve efficiency, reliability, and resilience against denial of service attacks. In addition, the technology includes redundant backup servers and failover IP address functionality so that devices 10 can connect to the cloud platform 50 even when a cloud platform 50 server is down, e.g., for maintenance. The user actions from the mobile software application are either sent directly from the user app to smart light adapter 10 (whenever the user is in the same location as smart light adapter 10 is e.g. home—in this case, actions are performed and later app updates the database at cloud to keep the record) or when a user is outside, the app sends all actions to cloud and cloud sends the actions to the smart light adapter and gets an acknowledgement of action performed from the smart light adapter. Therefore; a complete history of actions is kept on the cloud and this data is used to learn about user behaviors and later make suggestions for automated actions for energy efficiency to the user. The data is also used to show the user a history or timeline of their activities, where they can see the full audit trail of their usage. The data is also used to generate statistical graphs to the user about their usage styles.

FIG. 1B illustrates components of a smart light adapter 10 in some embodiments. The illustrated components include an onboard communication section 110, sensor section 120, processing section 130, energy measurement section 140, brightness control section 150, power section 160, and status section 170. In the illustrated embodiment, the communication section 110 has an onboard communication subsystem: a Wi-Fi module 111. For example, the smart light adapter 10 can function on Wi-Fi networks that operate on standard frequencies (2.4 GHz or 5 GHz) to send and receive data. Wi-Fi module 111 with implemented programs supports both direct and client mode operations. In some embodiments, the device selects the Wi-Fi operating mode depending upon, e.g., the requirement of operation and power metric indicators. The onboard sensor section 120 can include different types of sensors such as ambient light sensor 121, proximity detection sensor 122. These sensors can be standalone or on a single integrated semiconductor chip (IC). These sensors enable the smart light adapter 10 to operate in a smart mode. For example, since the ambient light sensor 121 is capable of detecting the amount of light in an environment, it can be an effective solution for power management. The brightness of the light producing device can automatically be adjusted brightness control section 150 in response to signals from the onboard sensor section 120. The role of the sensor section is to measure surrounding conditions in real time. The data is sent back to cloud platform 50 for storage, analysis and statistics. The same data is used by the smart light adapter 10 and onboard intelligent algorithms in conjunction with user controls data to learn about usage styles, usage behavior and implementation of smart control features in the smart light adapter. Initially the smart light adapter operates as per the user instructions without taking any automated decisions and enters the learning mode. With the increased data in the database and having learnt about user lifestyle and usage behavior it offers the user to enable smart control. If a user enables the smart control, device takes intelligent decisions to offer optimized convenience and control to the user without any user hassle.

In the illustrated embodiment, the processing section 130 has an onboard microcontroller unit 131, e.g., with on-chip flash and random access memory. The microcontroller unit 131 has onboard communication interfaces including, for example, serial communication, a serial peripheral interface, and an Inter-Integrated Circuit (“I2C”) bus for communication with the onboard subsystems. The smart light adapter 10 has onboard general purpose input/output (“I/Os”) and automatic data capture (“ADC”) for data capture, generating triggers and commands according to loaded program instructions. The microcontroller includes a processing and decision making engine. The programmatic and algorithmic flows are implemented in the onboard memory and are updated by the cloud application platform as required. For example, power metric calculations are part of the onboard algorithms which help the smart light adapter 10 save power during its operations. The programmatic and algorithmic flows with the help of the sensor section 110 and onboard rules engine enable the smart light adapter 10 to perform machine learning and to take intelligent decisions based on user habits. Energy measurement section 140 or circuitry is responsible for measuring the real time energy consumption of the light producing device coupled to the smart light adapter 10. For example, the energy measurement section can include existing single chip solutions to measure active energy (kWh). The brightness control section 150 is responsible for adjusting the brightness of the light based in response to user commands or in response to signals from the sensory section 120, or automatically when operating in smart mode. The power section 160 includes a power management circuitry to ensure optimal use of power by the device.

The onboard status section 170 provides visual status display about various modes, conditions and states of the smart light adapter 10. In some embodiments, red, blue, green and yellow LEDs are used. These can indicate various statuses regarding data transfer, cloud connection, mobile application connection, etc. In some embodiments a combination of two or more LEDs turned on simultaneously indicates system status for user information. In some embodiments, the smart light adapter 10 includes a display screen (e.g. LCD) that displays operational and status information.

In some embodiments, data in transit between the microcontroller 131 and Wi-Fi module 111 is secured by symmetric encryption such as a block cipher, e.g., AES-128, AES-192, or AES-256, and a one way hashing algorithm such as SHA1. AES block ciphers encrypt and decrypt data in blocks of 128 bits using cryptographic keys of 128-, 192- and 256-bits, respectively. Two-level encryption using AES and SHA1 for data in transit makes it difficult for an attacker to decrypt communication within the smart light adapter 10 between the microcontroller 131 and the Wi-Fi module 111.

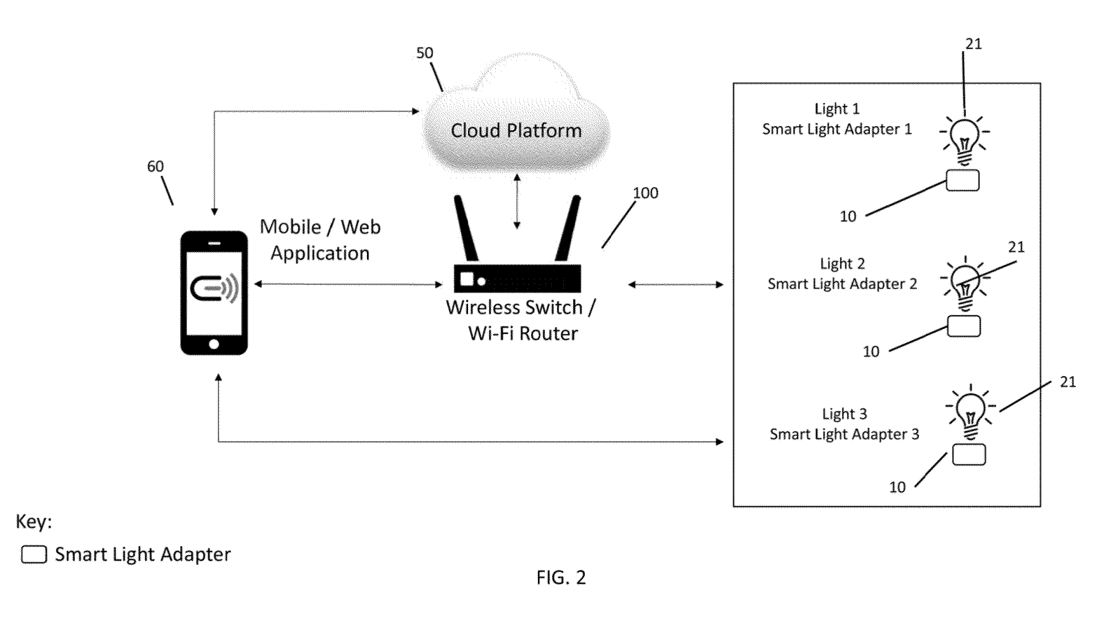

Referring to FIG. 2, smart light adapter 10 is connected to cloud platform 50 through Wi-Fi router 100 in client mode. The activity log is stored in the central database of cloud platform 50 and acknowledgements/notifications are sent to the user(s) through smartphone(s) 60. User actions are stored in the cloud platform 60. The smart light adapter 10 is initialized through onboard program of the microcontroller after it is powered up.

When the smart light adapter connects to the Server via TCP sockets it has to inform the cloud about its unique ID Address which is added to the Server's current connections list and is used for further handling the protocols and data for the device. The server checks if the unique ID Address is valid or not and responds with a message accordingly. If the device is not verified, the server closes the connection.

Once the smart light adapter is connected and listed in the current devices list it starts sending heartbeats after automatically adjusted intervals. The interval is adjusted intelligently and dynamically to balance the load on server side. The heartbeat fulfills multiple purposes. It helps in detecting if smart light adapter 10 is online or offline. The heartbeat also contains useful information about smart light adapter 10 such as information regarding schedule timestamps. It has other required information that is used for smart learning algorithms. The Cloud on the other hand keeps a record of the information in the heartbeat and after processing and storing information it sends an acknowledgement to the smart light adapter with a data packet having useful information for the smart switch. The smart light adapter status is set to offline if heartbeat is not received within specified time interval. These intervals are dynamic and depend on various parameters including current network situation, device health history and other relevant data.

Actions can be performed either locally or remotely from any location. If the smart light adapter is connected to the same Wi-Fi router or network as the mobile device on which the mobile app is executing, the actions are performed locally. In case the smart light adapter and mobile device are not connected to the same Wi-Fi router or network, the actions are performed remotely via the Cloud.

In Local action protocol the action information are communicated directed to the smart light adapter via the mobile device/mobile app, then the smart light adapter perform the action on the light producing device and sends an acknowledgement to let the user know when the action is performed. The mobile application then informs the cloud service that a local action was performed.

In Remote action protocol the mobile device/mobile app send action information to the cloud. A cloud service(s) process the information and sends it to the smart light adapter which then performs the action on the light producing device and sends an acknowledgement to the cloud. The cloud sets the status of the action as completely performed and sends a success notification to the mobile application.

Smart light adapter 10 can be controlled in different modes. In a Wi-Fi Direct mode, the smart light adapter 10 can be controlled directly from a Wi-Fi enabled mobile device without the need of a home Wi-Fi router. This is a built-in functionality in the Smart Light Adapter 10. All commands executed are locally saved in the mobile app database and as soon as it is linked to the internet, the data is transferred to the cloud to keep the database updated for optimized statistics. A second mode of operation is called “home mode”. When the user mobile device is connected to the home Wi-Fi Router, the same router on which the Smart Light Adapter is connected to, the light bulb can be controlled without the need of Internet accessibility. Data on executed commands are locally saved in the mobile app database and as soon as it is linked to the Internet, the data is transferred to the cloud platform 50 to keep the database updated for optimized statistics. A third mode of operation is called “Cloud Mode”. In order to control Smart Light Adapter 10 over the Internet, Smart Light Adapter 10 and mobile device must be connected to the Internet.

The main components of the smart light adapter 10 system are smartphone application or web applications 60 which executes on user electronic devices 60 and cloud application platform 50. These components remain essential in any of the embodiments of system deployments.

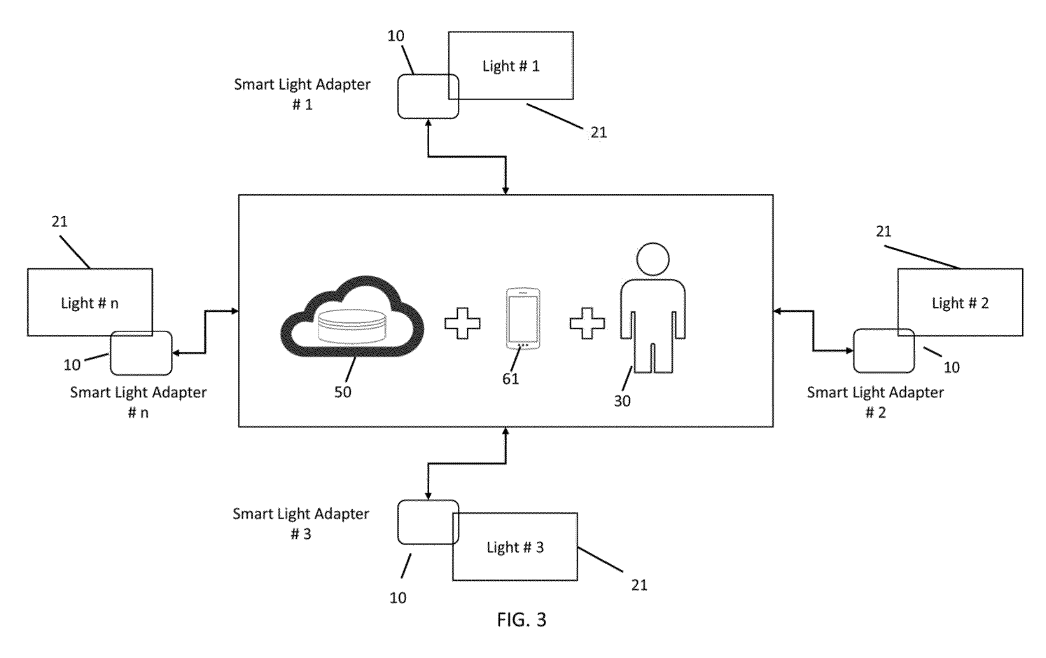

FIG. 3 shows a plurality of smart light adapters 10 coupled to light 21. The user 30 can control, monitor and manage their lights 21 through their smartphone(s) 60 and smart light adapters 10 irrespective of user 30 location. The smart light adapter controls associated lights through onboard subsystems as depicted in FIG. 1B. The acknowledgements and notifications are sent to user 30 through smartphone and smartphone application 60 and activity log is stored in cloud platform application database 50.

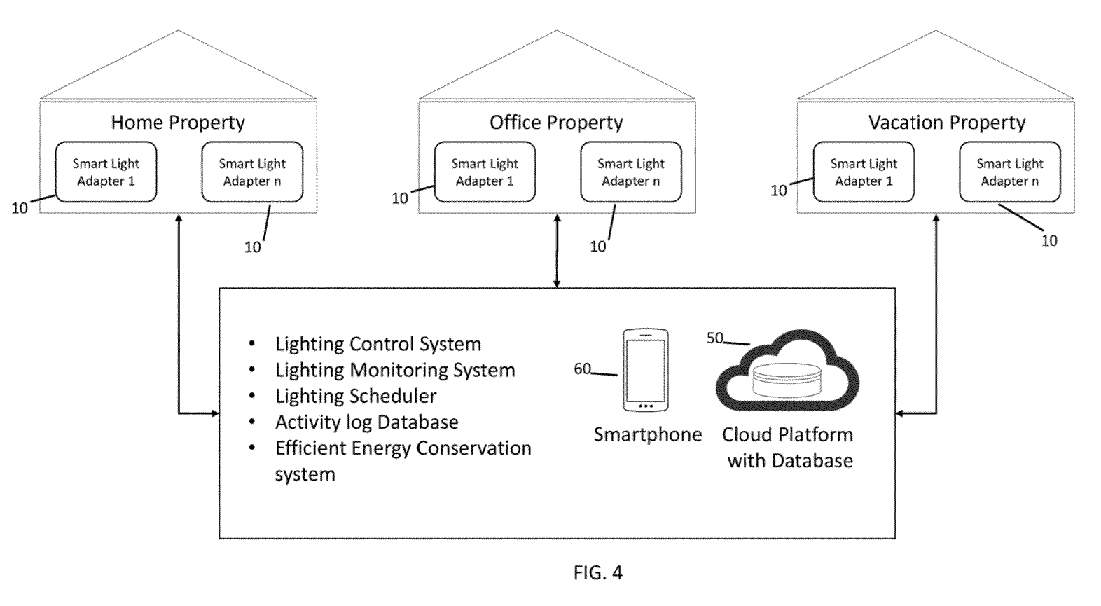

FIG. 4 is a high-level schematic diagram illustrating embodiments in which the technology can control lights at multiple properties. FIG. 4 shows application of the technology at various buildings, e.g., residential, office, vacation property, etc. The technology allows the user to deploy systems under various embodiments to control, monitor, and manage their light at one or plurality of buildings. Smart light adapters 10 can be deployed at multiple locations and user(s) can control the associated lights through a mobile or web interface 61 irrespective of their location(s). In some embodiments the user can choose to deploy multiple devices 10 at the same location for multiple lights 21, e.g., one device 10 per light 21 for cloud enabled control, monitoring and management of said lights 21 irrespective of user location.

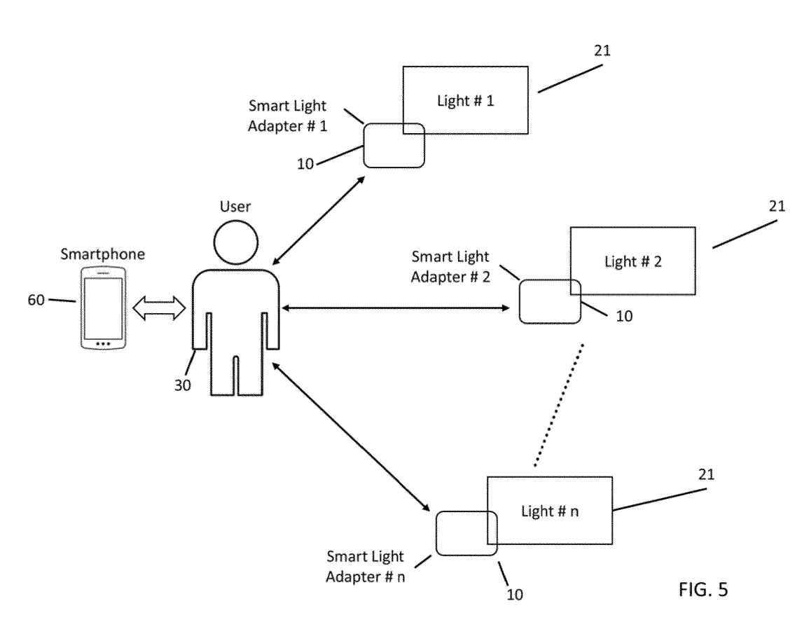

Referring to FIG. 5, it shows one of the deployment embodiments of the system. It is a schematic diagram where a user 30 is capable of communicating, controlling, monitoring and managing multiple lights 21 coupled to smart light adapters directly through software application installed on smartphone 60.

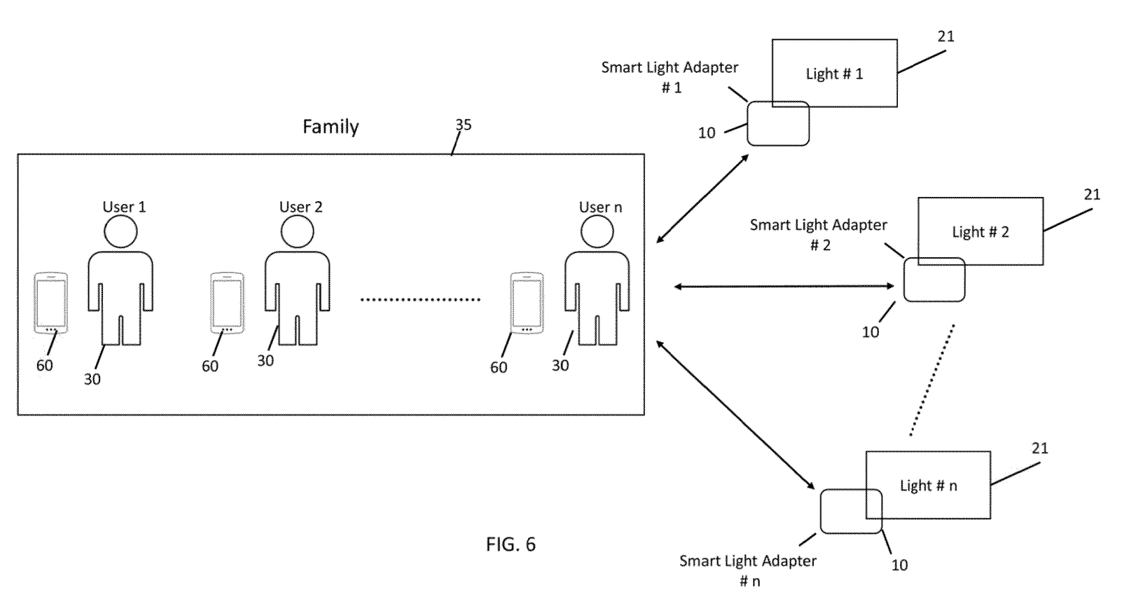

FIG. 6 is a high-level schematic diagram illustrating embodiments in which the technology enables multiple users to control multiple lights. In some embodiments, multiple users 30 that belong to a family or group 35—are capable of communicating, controlling, monitoring and managing multiple lights 21 coupled to multiple smart light adapters 10 directly through smartphones 60. In some embodiments, multiple users 30 are assigned to one device 10. In some embodiments there can be multiple users 30 assigned to multiple devices 10. In some embodiments there can be one user 30 assigned to multiple lights 21 through associated devices 10 that are geographically apart. In some embodiments there can be multiple users 30 assigned to multiple lights 21 through associated devices 10 that are geographically apart. The presented technology supports assignment of user(s) 30 through interactive graphical user interface which is part of the software application 61 and backend algorithmic and programmatic flows for effective remote monitoring, control and management of lights 21 through associated devices 10. The technology thus leverages cloud-enabled 50 control, monitoring and management capabilities to said users 30 for assigned lights 21 through the associated devices 10. Such implementation offers a family architecture of system usage and operation under various embodiments.

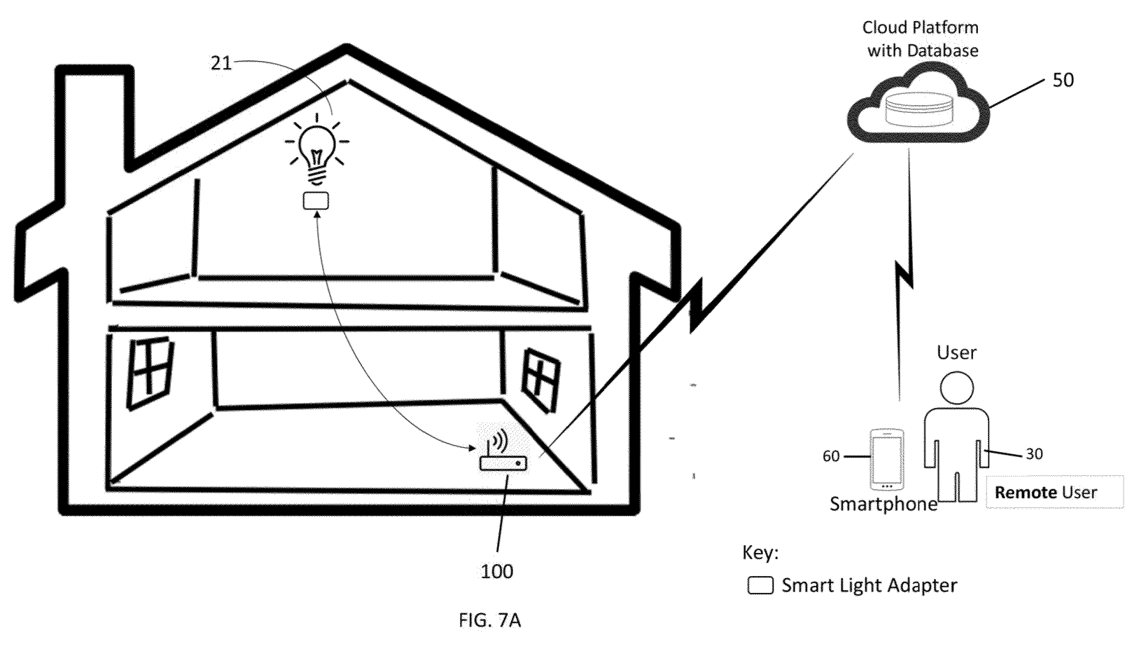

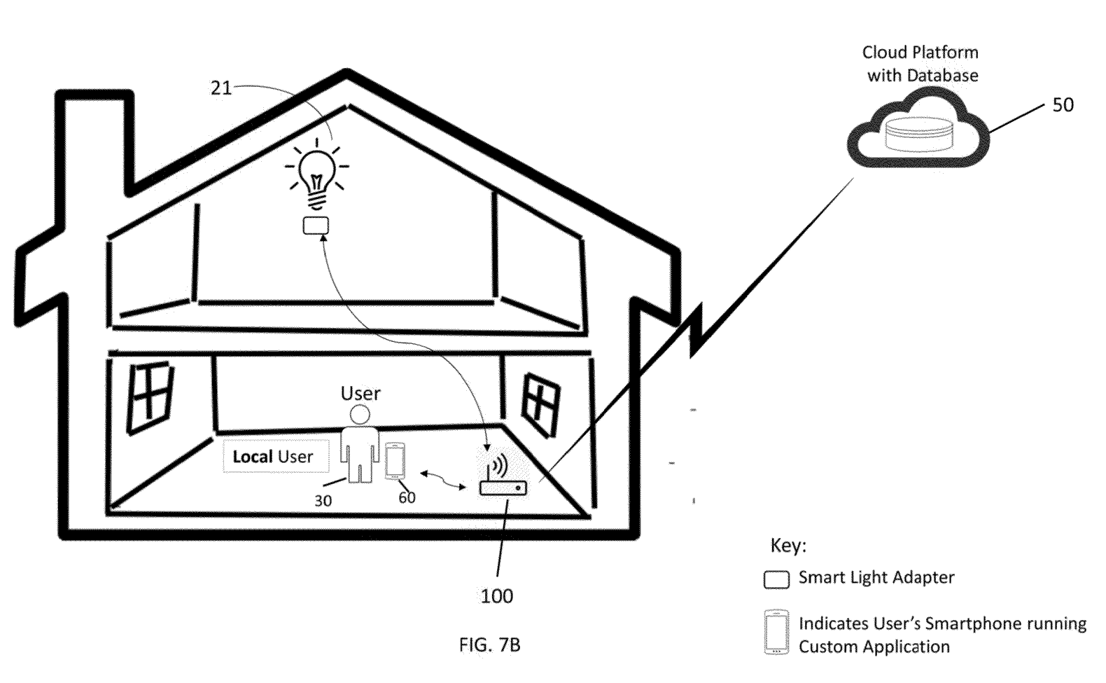

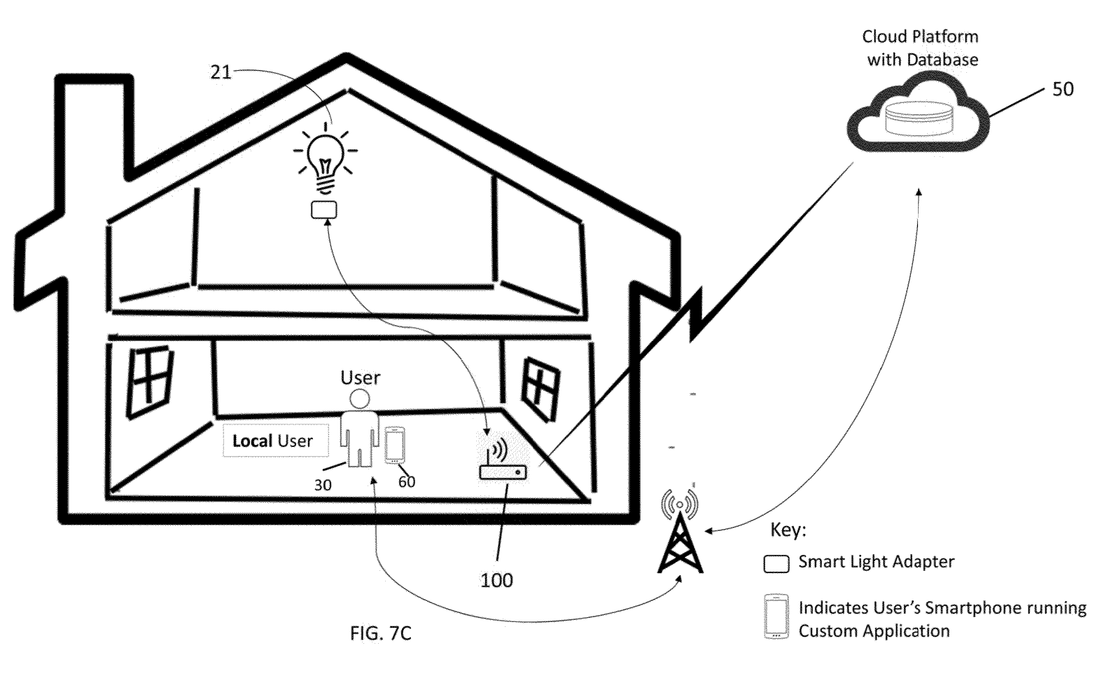

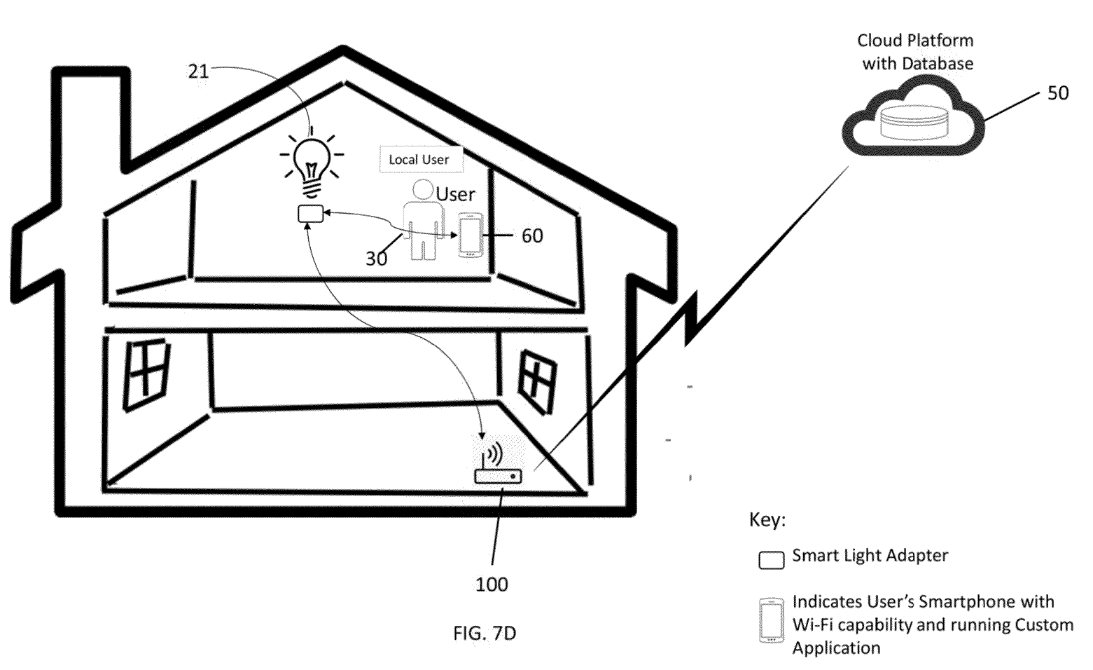

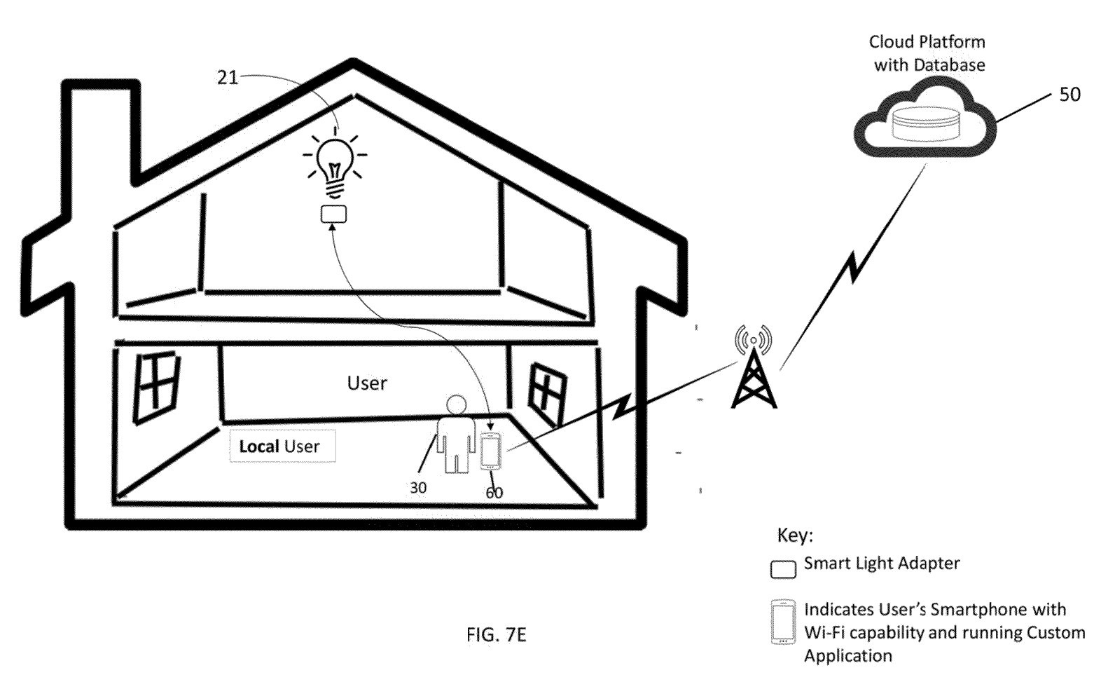

FIGS. 7A-7E are high-level schematic diagrams illustrating communication arrangements through which local and/or remote users can control light(s) 21 connected to smart light adapter(s) 10 in various embodiments of the technology. It should be noted that there is no intent to limit the disclosure to these arrangements; together with the arrangements described below, various possible options, modifications, equivalents, and alternatives fall within the spirit and scope of the present disclosure.

FIG. 7A illustrates a possible data communication mechanism where a remote user 30 is able to control, monitor and manage light 21 through smartphone application 60 and cloud application platform 50. The user 30 controls light 21 through associated smart light adapter. The command string from the user 30a through their smartphone application 60 is communicated to the smart light adapter through cloud application platform 50 and local Wi-Fi router 100. The communication between smart light adapter and Wi-Fi router 100 is based on local Wi-Fi connection. The communication of acknowledgement from the smart light adapter to the user smartphone application 60 is through local Wi-Fi router 100 and cloud application platform 50. The same communication mechanism is used to log activity feed in the cloud application platform database 50.

FIG. 7B illustrates a possible data communication mechanism where a local user 30 is able to control, monitor and manage light 21 through smartphone application 60 and cloud application platform 50 and local Wi-Fi router 100. The user 30 controls lights 21 through associated smart light adapter. The command string from the user 30 through their smartphone application 60 is communicated to the smart light adapter through local Wi-Fi router 100. The communication between smartphone application 60 and the local Wi-Fi router 100 as well as between local Wi-Fi router 100 and smart light adapter is based on Wi-Fi. The communication of acknowledgement from the smart light adapter to the user smartphone application 60 is through the local Wi-Fi router 100 and cloud application platform 50. The same communication mechanism is used to log activity feed in the cloud application platform database 50.

FIG. 7C illustrates a possible data communication mechanism where a local user 30 is able to control, monitor and manage light 21 through smartphone application 60, cloud application platform 50 and public cellular network infrastructure. The user 30 controls light 21 through associated smart light adapter. The command string from the user 30 through their smartphone application 60 is communicated to the smart light adapter through public cellular infrastructure link, cloud platform 50 and local Wi-Fi router 100. The communication of acknowledgement from the smart light adapter to the user smartphone application 60 is through Wi-Fi router 100, cloud application 50 and public cellular infrastructure.

FIG. 7D illustrates a possible data communication mechanism where a local user 30 is able to control, monitor and manage light 21 through smartphone application 60 and cloud application platform 50. The user 30 controls light 21 through associated smart light adapter. The command string from the user 30 through their smartphone application 60 is communicated to the smart light adapter through Wi-Fi connection between both. The communication of acknowledgement from the smart light adapter to the user smartphone application 60 is through Wi-Fi connectivity and cloud application platform 50. Smart light adapter uses local Wi-Fi router 100 to log activity feed in the cloud application platform database 50 through Wi-Fi connectivity.

Referring to FIG. 7E, it shows one of the application embodiments where a local user 30b is able to control, monitor and manage light 21 through smartphone application 60 and cloud application platform 50.

FIG. 7E illustrates possible data communication mechanisms in which local user(s) control the light through direct communication between the local smartphone and smart electrical switch. The communication between the local smartphone and the smart light adapter is based on direct communication, and the communication between the local user and the cloud application platform is based on public cellular telephone infrastructure.

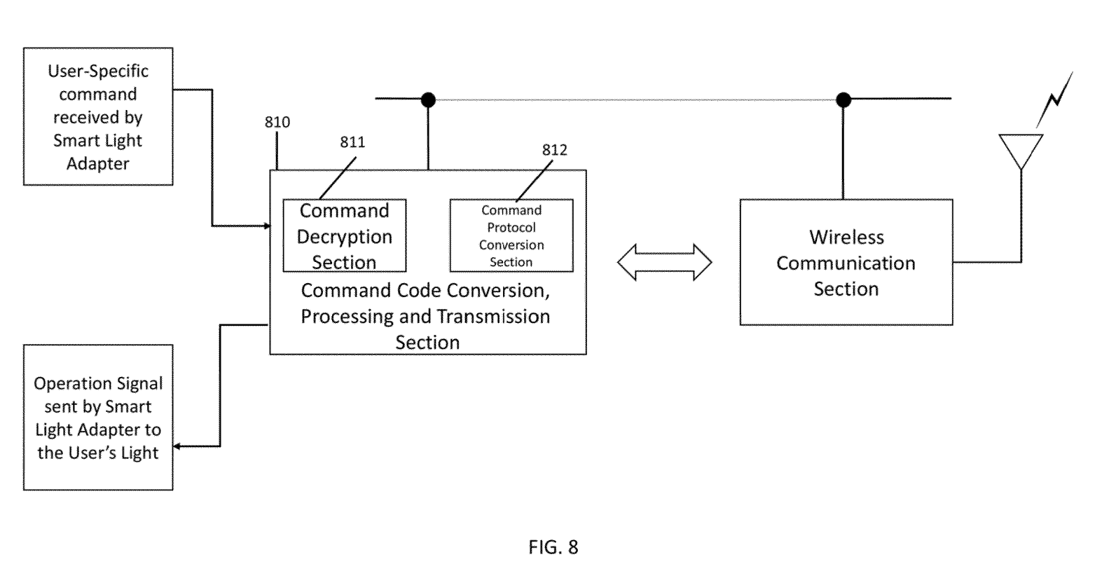

FIG. 8 is a block diagram illustrating how commands received by the smart light adapter are processed in accordance with some embodiments of the invention. The illustrated subsystems include a command operation section 810 which includes an onboard command decryption section 811 and command protocol conversion section 812, and an interface for wireless communication. The illustrated subsystems enable conversion, processing, and transmission of user-specific commands 801 to the user's appliance 21. The command operation section 810 of smart light adapter performs related processing on the user-specific commands. The processing includes command decryption 811 and command protocol conversion 812 to operational signals that smart light adapter can communicate to the light coupled to it.

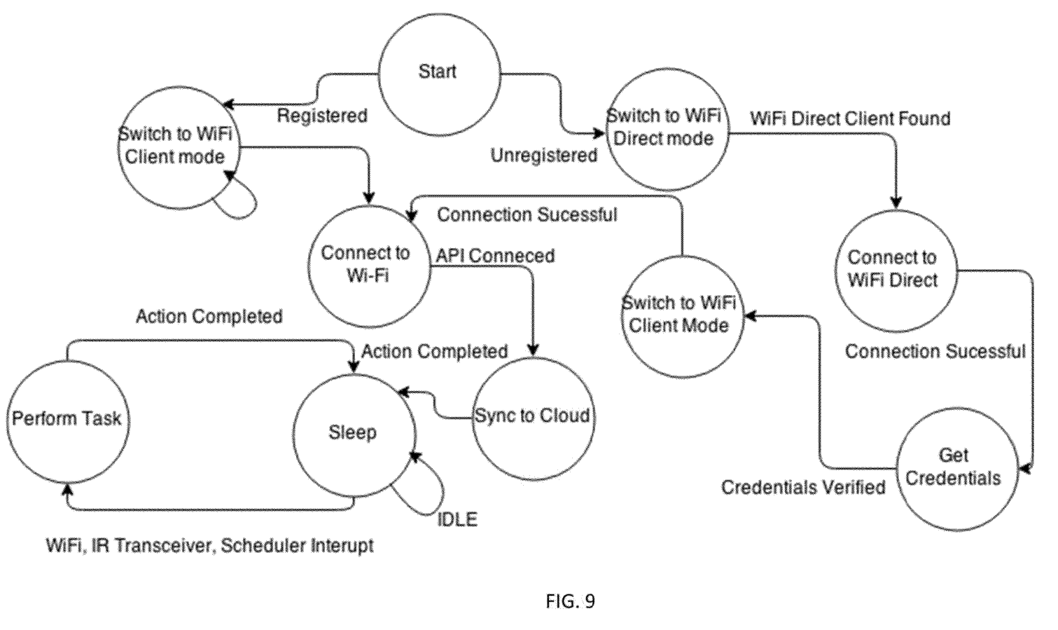

Referring to FIG. 9, it shows state diagram embodiment illustrating the communication routes and decision made by the smart light adapter in order to pass instructions. Start state represents the power-on self-test (POST). If the smart light adapter is registered, associated with a user, family, SSID or a service, it calculates the power metric probing all components and identifying system health. If the smart light adapter is unregistered, the state will switch to Wi-Fi Direct mode and search for Wi-Fi Direct clients. After getting and verifying Wi-Fi communication credentials by successfully connecting to Wi-Fi Direct channel, the smart light adapter state will switch to Wi-Fi client mode and connects to home wireless router.

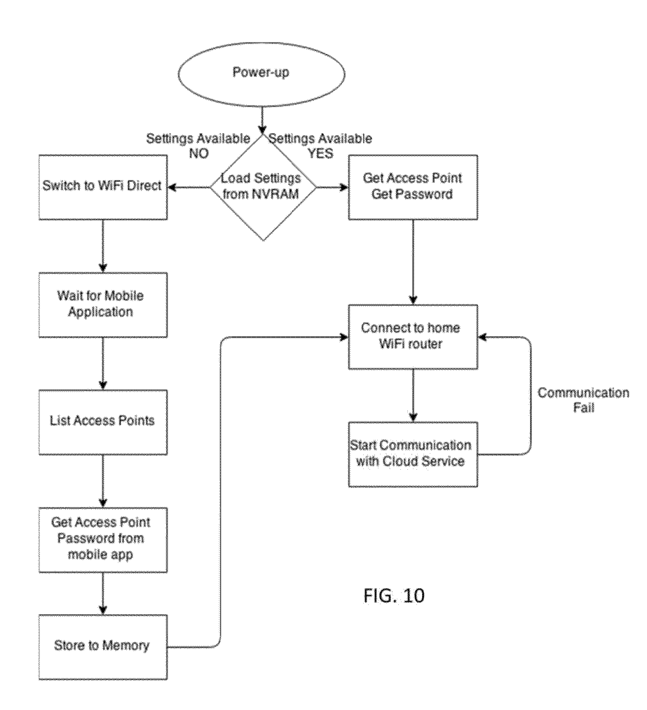

Referring to FIG. 10, it shows communication flowchart embodiment of the smart light adapter to cloud service. Upon power up, the system searches internal NVRAM (nonvolatile random access memory) for system setting. By default, these are empty. The settings include Wi-Fi home router username, password, power settings etc. When it fails to locate these settings, the smart light adapter switches Wi-Fi module to Wi-Fi direct mode. The mobile application connects to Wi-Fi direct and queries for listing available access points. The mobile application gets the name and password from the user and saves to system. The smart light adapter then switches Wi-Fi module back to client mode and connects to the home Wi-Fi router from where the communication to cloud platform establishes.

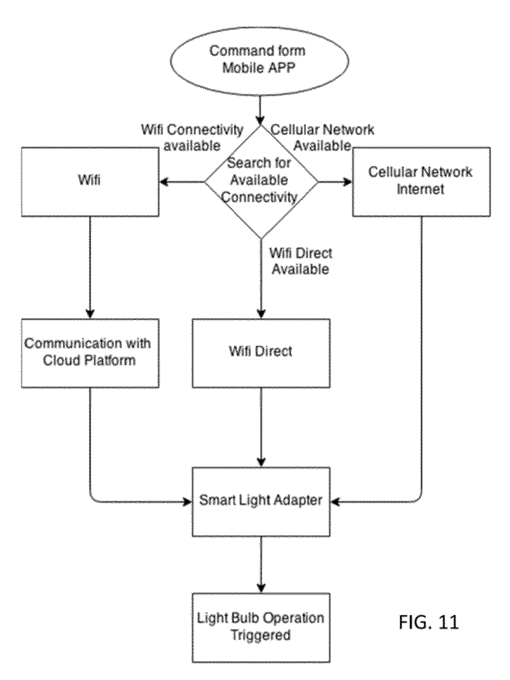

FIG. 11 is a flow diagram illustrating the steps involved in communication a command to the smart light adapter. The user device can issue commands to the smart light adapter via direct communication (e.g. Wi-Fi direct), via the home router, or via a cellular network that communicates the commands to the smart electrical switch via the cloud platform (e.g., user is remote from the location of the smart electrical switch).

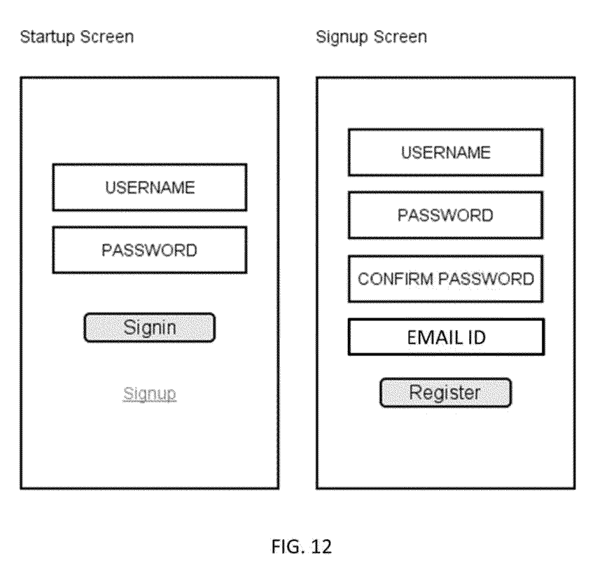

Referring to FIG. 12, it shows mobile application's startup screens of signing in of existing user and registration of new user. The sign in screen accepts the inputs of existing username and password of a registered user and displays “sign in”/“sign up” buttons. On the other hand, sign up screen requires the inputs of username, email, password and password confirmation of a new user and displays a “register” button.

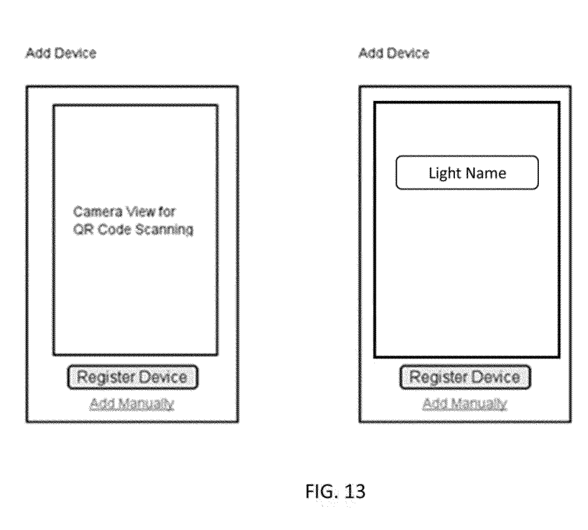

Referring to FIG. 13, it shows mobile application's device adding screens. It offers an automatic QR code scanning option which automatically detects the smart light adapter I.D and stores it in cloud against specific user. During the registration phase, the customized software application running on the mobile device retrieves the location of the user and communicates it to cloud platform where it is stored in one or more databases and become associated with the user profile and smart light adapter. The cloud platform hosts a database that contains data about various utilities providers in different locations (countries, states, cities, counties) as well as corresponding electricity rates (e.g., cost per kWh). This enables the customized software to calculate costs of energy consumed based on energy consumption measurements and reporting from the smart light adapter. The location of mobile device can be obtained in multiple ways. For example, the location of the mobile device can be based on the GPS coordinates of the device, or the location of the wireless Access Point the mobile device is connected to. There are many known ways for a mobile software application to obtain and report the location of the mobile device. For example, mobile applications designed to run on Apple iOS devices use the Apple's Core Location framework to locate the current position of the device. The smart light adapter can be delinked from one location and linked to another (in case the owner of the smart light adapter moves to a different city or state). In some embodiments, the smart light adapter can report data to a remote server that can compute its location. Such data might be related to the access point that it is connected to. Internal algorithms of the system ensure that smart light adapter 10 location is updated every time it is delinked from existing Wi-Fi router and linked to a new Wi-Fi router.

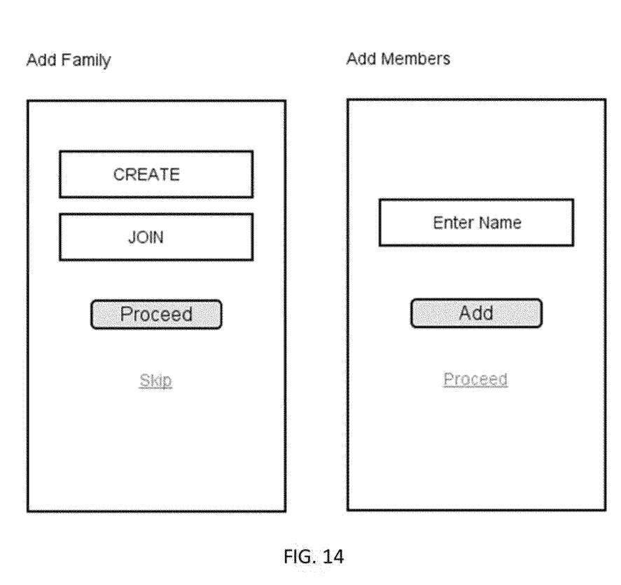

Referring to FIG. 14, it shows mobile application's family registration options screens. A user has the option to create a new family group or join the existing as a new member. The new member can have access to existing smart light adapter(s) associated with the family or can add new ones.

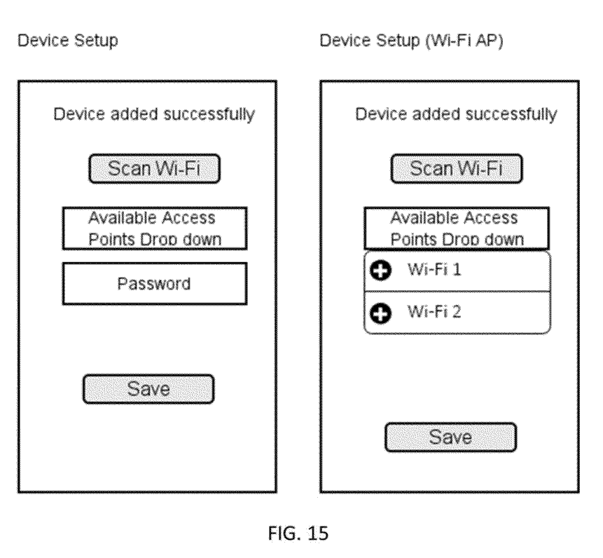

Referring to FIG. 15, it shows mobile application's device Wi-Fi communication setup screens. User can select available Wi-Fi access points from a drop-down menu and enter the access point password in order to establish communication through it. The Wi-Fi access point information and password will be saved in mobile application and cloud platform by selecting the save option.

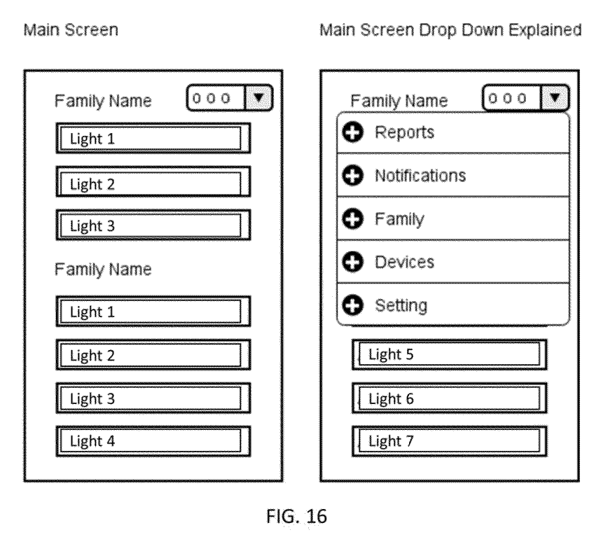

Referring to FIG. 16, it shows mobile application's family associated lights and drop down options screens. List of lights associated with a specific family is shown. More than one families can be registered as well as more than one lights can be associated with each family. The options drop down menu gives user access to graphical reports, notifications, family information, associated lights information, and settings screens.

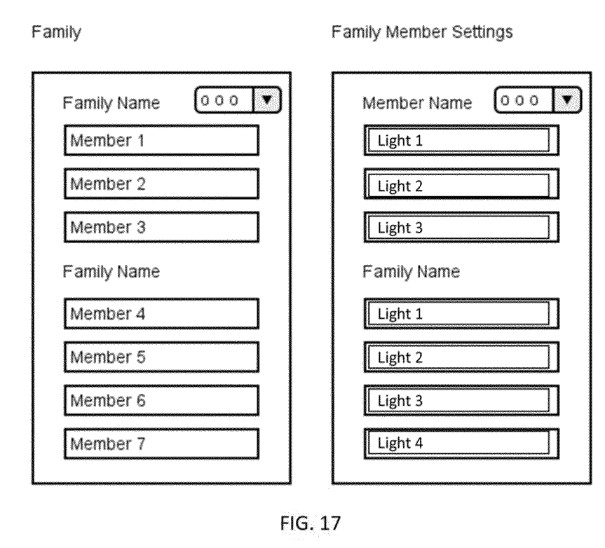

Referring to FIG. 17, it shows mobile application's family associated lights and member associated lights screens. List of lights associated with a specific family is shown. There can be more than one families registered and more than one lights associated with each family. Additionally, list of smart light adapters associated with each member is shown here. There can be more than one members registered in a family and more than one smart light adapters associate with each member of the family.

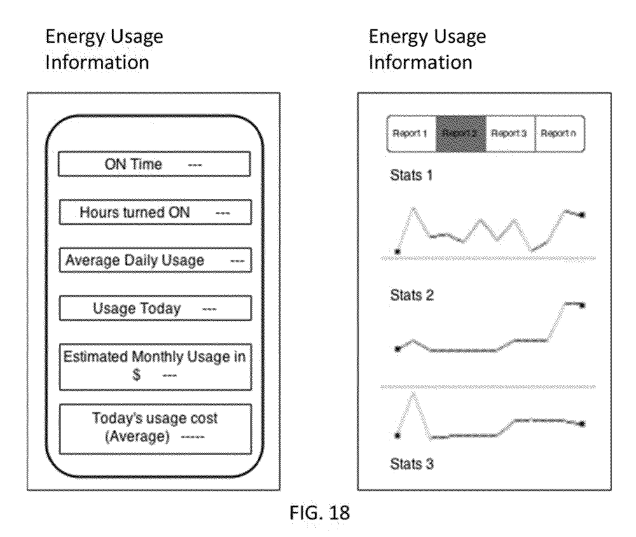

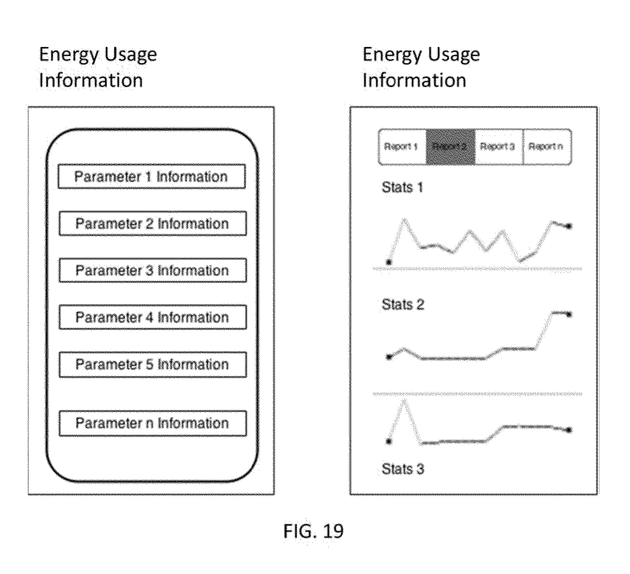

Referring to FIGS. 18 and 19, these show mobile application's screens and functions available for showing energy usage of lights to the user. User can make energy saving decisions from this vital information and contribute to global challenges of saving energy.

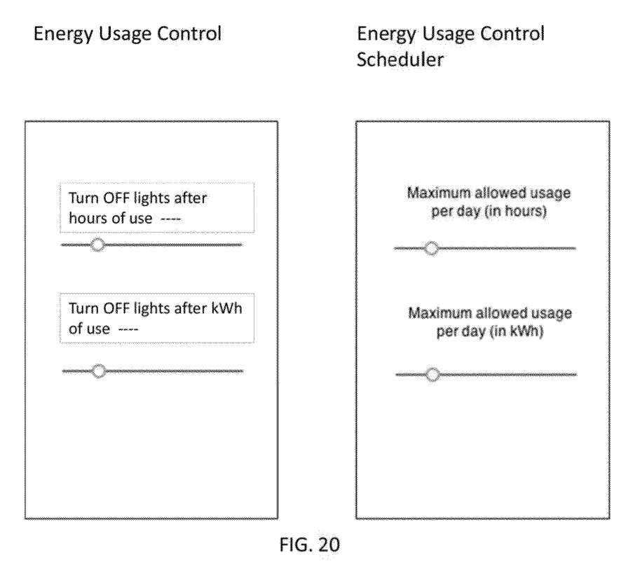

Referring to FIG. 20, it shows mobile application's screens and functions available for energy usage control measures. User can make energy saving decisions and restrict energy usage of various lights associated to smart light adapters.

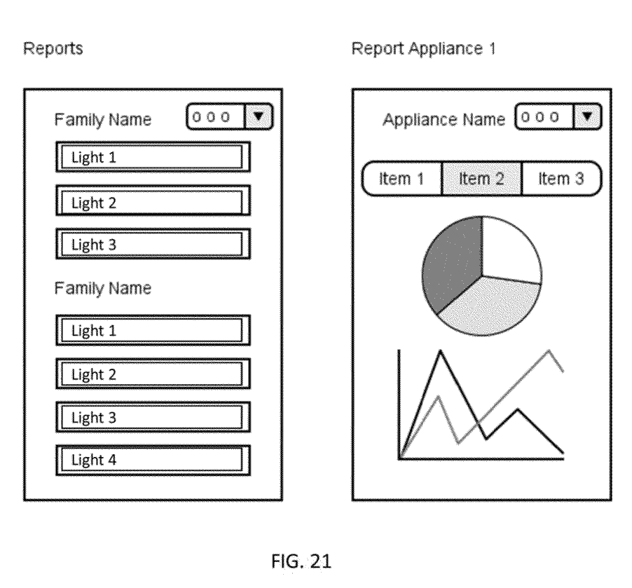

Referring to FIG. 21, it shows mobile application's family associated lights and graphical reports of specific light screens. List of lights associated with a specific family is shown. There can be more than one families registered and more than one lights associated with each family.

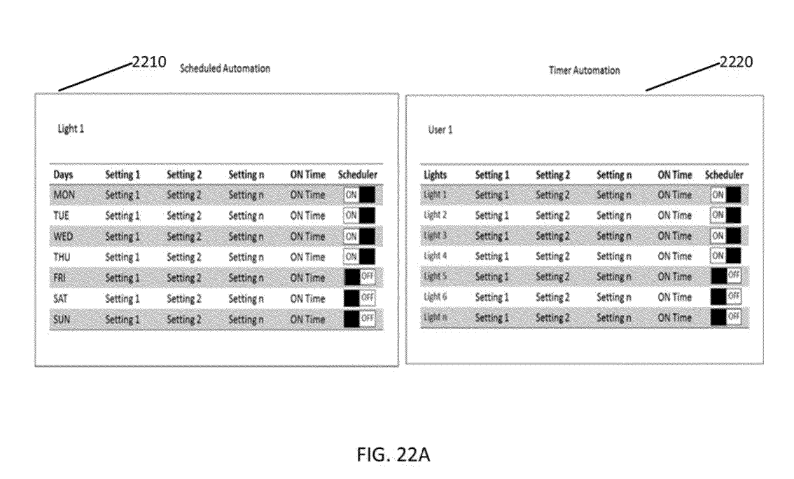

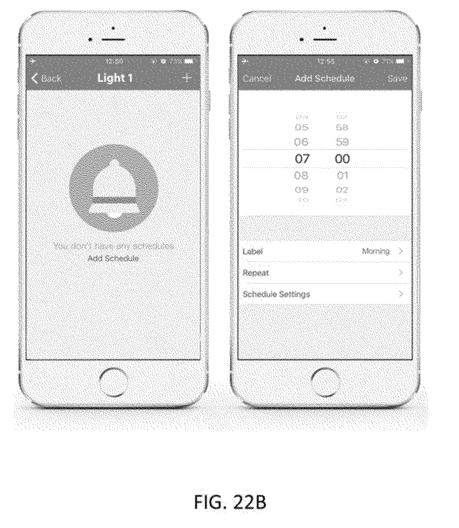

FIGS. 22A-22B are display diagrams illustrating scheduling functionality in accordance with some embodiments of the technology. The technology enables users to set schedules and automated timers for operating a light producing device associated with a smart light adapter 10, such as turn ON the lights to make the house appear occupied and deter burglars while the occupants are away. FIG. 22A shows a graphical user interface 2210 where a user can select settings to be automatically performed on selected smart light adapter(s) 10 over the days of the week. Timer automation screen 2220 enable a user to automatically triggering a number of user-specific settings over all available smart light adapters 10.

FIG. 22B shows a scheduling interface for smart light adapter 10. The scheduling functionality enables a user to schedule functions to be performed over time. Functions may include turning ON/OFF the light at specific times, or dimming the light, etc. The scheduling functionality is handled by a “Schedule Protocol” by which schedules that are added by a user against any smart light adapter 10 are also sent to the smart light adapter 10 via cloud platform 50. Schedules can be deleted, enabled, or disabled by the user using the custom software application installed on a user device such as a mobile phone, tablet, smart watch, TV, etc.

In some embodiments, the cloud platform 50 sends a fixed number of schedules or schedule events to smart light adapter 10 to be executed after processing, along with data string and timestamp, and stores the remaining schedules or schedule events as a queue in its database. Smart light adapter 10 sends an acknowledgment for each schedule information. When the schedule is executed, device 10 sends a schedule execution acknowledgement to cloud platform 50 along with the timestamp information of that schedule. The cloud platform 50 marks that schedule as completed and then gets pending schedules and sends them to device 10. Normally, five latest schedules to be executed next are stored in the smart light adapter 10 memory to ensure that schedules work even if internet connection to the cloud platform 50 is disconnected.

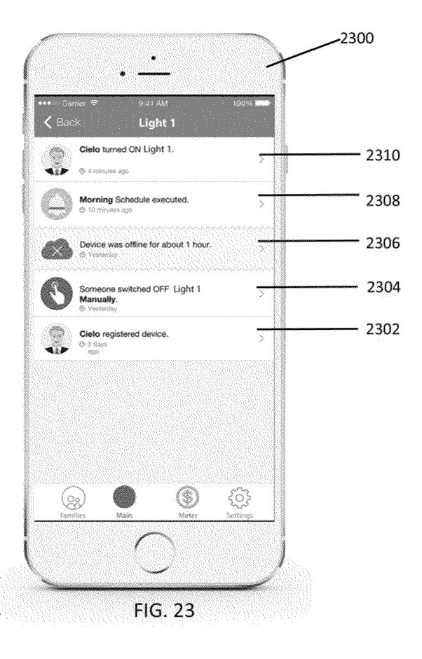

FIG. 23 is a display diagram illustrating a timeline view in accordance with some embodiments of the technology. Timeline view 2300 enables a user to see actions performed on smart light adapter 10 and observed through smart light adapter 10 therefore providing a complete audit trail. In the shown timeline view 2300, item 2302 is the oldest item and indicates that Cielo registered device named “Light 1” two days ago. Item 2304 indicates that “Someone switched OFF Light 1 MANUALLY”. In some embodiments, smart light adapter 10 captures and reports status information that are displayed in timeline view 2300. Item 2306 indicates that Light 1 was offline for an hour. Item 2308 indicates that a schedule labeled “Morning” was executed ten minutes ago. Item 2310 indicates that Cielo turned ON light 1 four minutes ago. In some embodiments, the technology provides auditing functions based on observed timeline events, such as an alert that a function was performed outside normal hours.

There is a multitude of advantages of the presented invention arising from the various features of the smart light adapter, its methods, subsystems, algorithms and associated applications. It is pertinent to note that alternative embodiments of the present invention may not cover all of the associated features of the invention. People having ordinary skills in the art may benefit and devise their own implementations of the smart light adapter, utilizing one or more of the features of present invention which fall within the scope of the present invention as defined by the appended claims.

It will be appreciated by those skilled in the art that the above-described technology may be straightforwardly adapted or extended in various ways. For example, the technology may be implemented in devices of various sizes and forms, as standalone devices or integrated or retrofitted into appliances. While the foregoing description makes reference to particular embodiments, the scope of the invention is defined solely by the claims that follow and the elements recited therein.

What is claimed is:

1. A smart light adapter comprising:
a control circuit configured to be coupled to an electrical power supply, and to a light producing device;
the control circuit comprising:
a communication module configured to receive at least one RF packet comprising at least one of a control command and a configuration command;
a processing module for processing the at least one control command and the one configuration command, and generating operational signals;
a control module for receiving the operational signals and executing functions associated with the operational signals.

2. The smart light adapter of claim 1, further comprising:
a first fixture surface mechanically connectable to a light socket;
a first electrical connector included in the first fixture surface for coupling the control circuit and the light producing device to an electrical supply in the light socket;
a second fixture surface mechanically connectable to the light producing device;
a second electrical connector included in the second fixture surface for coupling the control circuit to the light producing device.

3. The smart light adapter of claim 1, wherein the communication module comprises a Wi-Fi communication transceiver.

4. The smart light adapter of claim 1, wherein the control circuit is configured to receive a brightness control command from a user over a network.

5. The smart light adapter of claim 4, wherein the network is at least one of a local area network, and an ad-hoc network.

6. The smart light adapter of claim 1, wherein the smart light adapter operates in a smart control mode based on usage behavior data collected over time.

7. The smart light adapter of claim 1, wherein the control circuit comprises an energy measurement module configured for measuring an energy consumption of the light producing device.

8. The smart light adapter of claim 2, wherein the light socket is at least one of an Edison, Bayonet, and a Downlight light socket.

9. The light adapter of claim 1, wherein the control circuit further comprises a proximity sensor, wherein the brightness of the light producing device changes in response to a signal from the proximity sensor or turns ON/OFF.

10. A method in a networked control system for remotely controlling at least one smart light adapter, the method comprising:
determining a list of online smart light adapters associated with a user profile,
displaying the list of the online smart light adapters on a user communication device,
receiving, over a communication network, a command from the user communication device to control a light producing device associated with one of the online smart light adapters;
controlling the light producing device responsive to the command.

11. The method of claim 10, wherein displaying the list of the online smart adapters includes grouping the smart light adapters according to a user predefined selection.

12. The method of claim 10, wherein the communication network is at least one of a LAN network, a cellular network, and an ad-hoc network.

13. The method of claim 10, further comprising:
monitoring an energy consumption of the light producing device; and
altering the operation of the light producing device responsive to the energy consumption exceeding an energy consumption threshold.

14. The method of claim 13, further comprising:
periodically sending at least one of a report of energy consumption of a light producing device coupled the smart light adapter, and actions performed on the light producing device, to a remote server.

15. The method of claim 13, wherein the energy consumption threshold relates to a time period in which the light producing device has been producing light.

16. A remote control system for controlling a light producing device over a communication network, the system comprising:
a cloud application platform, comprising at least one processor and memory;
a user interface component of a user computing device operably connected with the cloud computing platform; and
a smart light adapter having a communication module, the smart light adapter operably connected to the cloud computing platform via the communication module and configured to be associated with a light producing device, and configured to receive a command from a user over the communication network to control the light producing device.

17. The remote control system of claim 16 wherein the user interface component is configured to display a list of smart light adapters that are capable of receiving a control command associated with a location within an environment.

18. The remote control system of claim 16 wherein the smart light adapter is operative to form a network with at least one other transceiver via said communication module.

19. The remote control system of claim 16 further comprising an energy consumption monitoring and reporting module configured to periodically report energy consumption to a remote server.

20. The remote control system of claim 19, wherein the energy consumption relates to a time period in which a light producing device has been producing light.
